(19) United States
(12) Patent Application Publication
(10) Pub. No.: US 2010/0002012 A1
(43) Pub. Date: Jan. 7, 2010

(54) METHODS, ELECTRONIC DEVICES, AND COMPUTER PROGRAM PRODUCTS FOR PROVIDING GEOGRAPHICAL PRESENCE USING MAP TILES

(75) Inventor: Markus Mans Folke Andreasson, Lund (SE)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 12/167,761

(22) Filed: Jul. 3, 2008

(51) Int. Cl. G09G 5/00; G01C 21/00; G06T 11/00; H04M 1/00

(52) U.S. Cl. 345/619; 701/208; 345/467; 455/556.1

(57) ABSTRACT

An electronic device is operated by determining an approximate geographic location of the electronic device, determining a zoom level for a geographic map tile that encompasses the approximate geographic location, determining horizontal and vertical coordinates for the geographic map tile based on the zoom level and the approximate geographic location of the electronic device, and sending the horizontal and vertical coordinates and zoom level to another device as a geographic presence indicator for the electronic device. Related electronic devices and computer program products are also provided.

### BACKGROUND OF THE INVENTION

The present invention relates to electronic devices and methods and computer program products for operating the same and, more particularly, to electronic devices, methods, and computer program products for providing geographical presence information.

In Web based map services, such as Google Maps and Yahoo Maps, the map of a certain location is rendered using a set of pre-rendered tiles. These map tiles comes from what is known as a Mercator projection of the surface of the earth from −180 degrees west to 180 degrees east and approximately 85 degrees north to approximately −85 degrees south. The Mercator projection represents a flattening of the near-spherical surface of the earth into a rectangular area. This rectangular surface area is then split into a grid of equally sized map tiles (e.g., 256×256 pixels each). The size of the grid defines the zoom level for each map tile. Typically, there are a set of about 18 such grids for each map service ranging from 1×1 tiles up to 131072×131072 tiles (i.e., 2^{z} times 2^{z} tiles where z ranges from 0 to 17). Each map tile is uniquely identified by zoom level (z), horizontal coordinate (x) and vertical coordinate (y), where z=[0, 17], x=[0, 2^{z}−1] and y=[0, 2^{z}−1]. Finding the corresponding map tile for a certain location when zooming out may be a relatively simple task: subtract 1 from z and integer divide x and y by 2.

When a map service needs to render a rectangular area (represented by four points of latitude and longitude coordinates) somewhere on earth it calculates which zoom level (z) is needed and then the needed sub-grid from the map tile grid corresponding to z. This sub-grid is found by calculating which map tiles contain the four points spanning the area to render. The minimum sub-grid needed to draw an area is 1×1 tiles, i.e., a single tile. A single map tile is always sufficient, independent of zoom level, when you want to render a single point.

A de facto standard for the tile grids has been established, which means that a map tile from Google Maps can be replaced by a corresponding tile from Yahoo Maps. In other words, the offset points for all map tiles related to the entire Mercator projection of the surface of the earth, independent of map service source, are the same.

When one person/device provides a geographical presence to another person/device there are situations when an exact position may not be preferred, e.g., for integrity reasons. There are several known ways to obfuscate the position of a person/device before presenting it to another person/device, such as, for example, by adding a random “noise” to the latitude and longitude coordinates. A potential drawback with this approach is that such a false position may still be perceived as an exact position. Another way is to lookup an appropriate address, city name, or region depending on the desired level of obfuscation, e.g., Kensington, London, England, Europe, which is then used as the geographical presence. A potential drawback with this approach is that such a lookup may be quite complex to perform for each geographical location and may also fail if the location is unknown to the lookup service.

### SUMMARY OF THE INVENTION

According to some embodiments of the present invention, an electronic device is operated by determining an approximate geographic location of the electronic device, determining a zoom level for a geographic map tile that encompasses the approximate geographic location, determining horizontal and vertical coordinates for the geographic map tile based on the zoom level and the approximate geographic location of the electronic device, and sending the horizontal and vertical coordinates and zoom level to another device as a geographic presence indicator for the electronic device.

In other embodiments, determining the approximate geographic location includes using a navigation module to determine the approximate geographic location.

In still other embodiments, the navigation module is a Global Positioning System (GPS) unit.

In still other embodiments, determining the approximate geographic location includes displaying at least a part of a map on the electronic device and receiving user input that identifies the approximate geographic location of the electronic device on the map.

In still other embodiments, displaying the at least part of the map includes changing the part of the map displayed on the electronic device responsive to the user input.

In still other embodiments, displaying the at least part of the map includes changing the zoom level for the at least part of the map responsive to the user input.

In still other embodiments, the zoom level is given by Z, the horizontal coordinate has a range from 0 to 2^{Z-1}, and the vertical coordinate has a range from 0 to 2^{Z-1}.

In still other embodiments, the method further includes changing the zoom level responsive to user input.

In still other embodiments, changing the zoom level includes providing a plurality of default zoom levels associated with a plurality of possible recipients of the geographic map tile, respectively and receiving a selection of one of the plurality of default zoom levels.

In still other embodiments, the method further includes adding Points Of Interest (POI) to the geographic map tile.

In still other embodiments, the electronic device is a mobile terminal.

In further embodiments of the present invention, an electronic device includes a controller configured to determine an approximate geographic location of the electronic device, to determine a zoom level for a geographic map tile that encompasses the approximate geographic location, to determine horizontal and vertical coordinates for the geographic map tile based on the zoom level and the approximate geographic location of the electronic device, and to send the horizontal and vertical coordinates and zoom level to another device as a geographic presence indicator for the electronic device.

In still further embodiments, the controller is further configured to determine the approximate geographic location by using a navigation module to determine the approximate geographic location.

In still further embodiments, the navigation module is a Global Positioning System (GPS) unit.

In still further embodiments, the controller is further configured to determine the approximate geographic location by displaying at least a part of a map on the electronic device and receiving user input that identifies the approximate geographic location of the electronic device on the map.

In still further embodiments, the controller is further configured to display the at least part of the map by changing the part of the map displayed on the electronic device responsive to the user input.

In still further embodiments, the controller is further configured to display the at least part of the map by changing the zoom level for the at least part of the map responsive to the user input.

In other embodiments of the present invention, a computer program product for operating an electronic device includes a computer readable storage medium having computer readable program code embodied therein. The computer readable program code includes computer readable program code configured to determine an approximate geographic location of the electronic device, computer readable program code configured to determine a zoom level for a geographic map tile that encompasses the approximate geographic location, computer readable program code configured to determine horizontal and vertical coordinates for the geographic map tile based on the zoom level and the approximate geographic location of the electronic device, and computer readable program code configured to send the horizontal and vertical coordinates and zoom level to another device as a geographic presence indicator for the electronic device.

In still other embodiments, the computer readable program code configured to determine the approximate geographic location includes computer readable program code configured to use a navigation module to determine the approximate geographic location.

In still other embodiments, the computer readable program code configured to determine the approximate geographic location includes computer readable program code configured to display at least a part of a map on the electronic device and computer readable program code configured to receive user input that identifies the approximate geographic location of the electronic device on the map.

Other electronic devices, methods, and/or computer program products according to embodiments of the invention will be or become apparent to one with skill in the art upon review of the following drawings and detailed description. It is intended that all such additional electronic devices, methods, and computer program products be included within this description, be within the scope of the present invention, and be protected by the accompanying claims.

### BRIEF DESCRIPTION OF THE DRAWINGS

The accompanying drawings, which are included to provide a further understanding of the invention and are incorporated in and constitute a part of this application, illustrate certain embodiments of the invention. In the drawings:

FIG. 1 is a block diagram of a an electronic device that can provide a geographical presence terrestrial and satellite communication system in accordance with some embodiments of the present invention;

FIG. 2 is a block diagram that illustrates the electronic device of FIG. 1 in accordance with some embodiments of the present invention;

FIG. 3 is a flowchart that illustrates operations of the electronic device of FIGS. 1 and 2 in accordance with some embodiments of the present invention; and

FIGS. 4-7 are examples of displaying a geographical presence in accordance with some embodiments of the present invention.

### DETAILED DESCRIPTION

The present invention will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

Some embodiments are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

While various embodiments of the invention are described herein with reference to Global Positioning System (GPS) satellites, it will be appreciated that they are applicable to any navigation system including, but not limited to, positioning systems that utilize pseudolites or a combination of satellites and pseudolites. Pseudolites are ground-based transmitters that broadcast a signal similar to a traditional satellite-sourced GPS signal modulated on an L-band carrier signal, generally synchronized with GPS time. The term “satellite,” as used herein, is intended to include pseudolites or equivalents of pseudolites, and the term GPS signals, as used herein, is intended to include GPS-like signals from pseudolites or equivalents of pseudolites. Also, while the following discussion references the United States GPS system, various embodiments herein can be applicable to similar satellite positioning systems, such as the GLONASS system or GALILEO system. The term “GPS”, as used herein, includes such alternative satellite positioning systems, including the GLONASS system and the GALILEO system. Thus, the term “GPS signals” can include signals from such alternative satellite positioning systems.

As used herein, the term “mobile terminal” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a GPS receiver; and a conventional laptop and/or palmtop receiver or other appliance that includes a radiotelephone transceiver. Mobile terminals may also be referred to as “pervasive computing” devices.

For purposes of illustration, embodiments of the present invention are described herein in the context of a mobile terminal. It will be understood, however, that the present invention is not limited to such embodiments and may be embodied generally as an electronic device that is capable of providing access to a map application for determining coordinates of a geographic map tile and may also communicate with other devices over, for example, a network or via a point-to-point communication protocol.

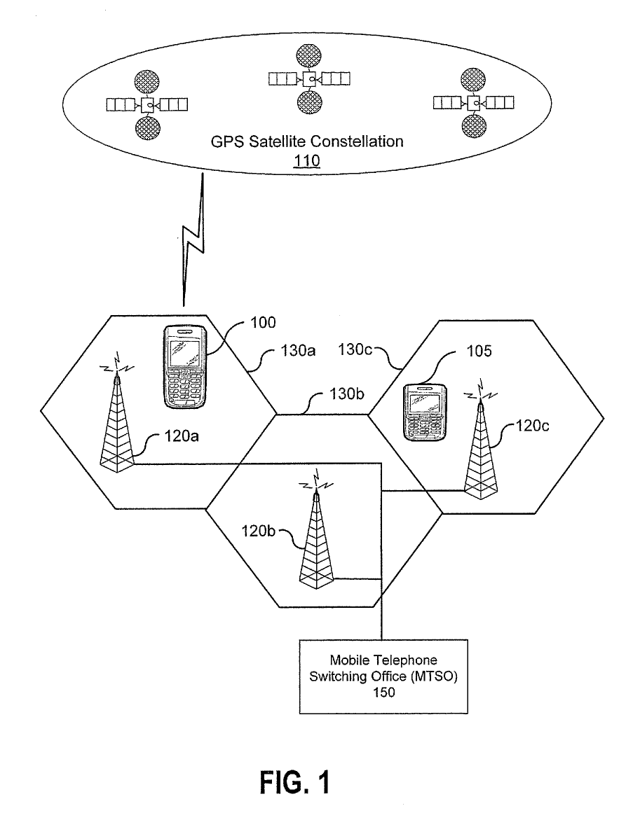

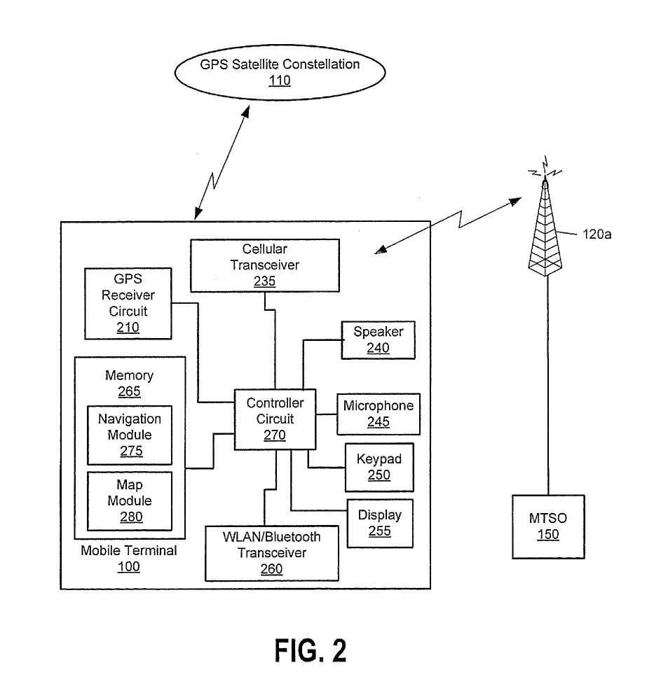

FIG. 1 is a schematic block diagram of a terrestrial and satellite communication system that includes a mobile terminal 100 that can provide a geographical presence in accordance with some embodiments of the present invention. FIG. 2 is a schematic block diagram that illustrates further aspects of the mobile terminal 100 shown in FIG. 1.

Referring to FIG. 1, the mobile terminal 100 includes a GPS receiver circuit that is operable to determine a geographic location of the mobile terminal 100 using GPS radio signals that are received from a constellation of GPS satellites 110. The GPS is a space-based radio triangulation system using a constellation of satellites in orbit around the earth. A GPS receiver triangulates its position based on timing of radio signals it receives from various ones of the satellites and the known location of those satellites. Determining the position of a GPS receiver typically requires the acquisition of a set of navigational parameters from the navigational data signals of four or more GPS satellites.

The mobile terminal 100 may further include a cellular transceiver that can communicate with a plurality of cellular base stations 120a-c, each of which provides cellular communications within their respective cells 130a-c. Each of the cellular base stations 120a-c may communicate with a Mobile Telephone Switching Office (MTSO) 150. The cellular base stations 120a-c along with the MTSO 150 may facilitate communication between the mobile terminal 100 and other mobile terminals in the same cell as the mobile terminal 100 or mobile terminals in other cells, such as mobile terminal 105.

Although FIG. 1 illustrates an exemplary communication network, it will be understood that the present invention is not limited to such configurations, but is intended to encompass any configuration capable of carrying out the operations described herein.

Referring now to FIG. 2, the mobile terminal 100 shown in FIG. 1 is illustrated in greater detail in accordance with some embodiments of the present invention. The mobile terminal 100 includes a GPS receiver circuit 210, a cellular transceiver 235, a speaker 240, a microphone 245, a keypad 250, a display 255, a WLAN/Bluetooth transceiver 260, and a memory 265 that communicate with a controller circuit 270. The GPS receiver circuit 210 receives GPS radio signals from visible satellites and measures the time that the radio signals take to travel from the respective GPS satellites to the mobile terminal 100. By multiplying the travel time by the propagation speed, the GPS receiver circuit 210 calculates a range for each satellite in view. Ephemeris information provided in the GPS radio signal describes the satellite's orbit and velocity, thereby enabling the GPS receiver circuit 210 to calculate the position of the mobile terminal 100 through a process of triangulation

The cellular transceiver 235 can be configured to encode/decode and control communications according to one or more cellular protocols, which may include, but are not limited to, Global Standard for Mobile (GSM) communication, General Packet Radio Service (GPRS), enhanced data rates for GSM evolution (EDGE), code division multiple access (CDMA), wideband-CDMA, CDMA2000, and/or Universal Mobile Telecommunications System (UMTS). The foregoing components of the mobile terminal 100 may be included in many conventional mobile terminals and their functionality is generally known to those skilled in the art.

The controller circuit 270 communicates with the memory 265 via an address/data bus. The controller circuit 270 may be, for example, a commercially available or custom microprocessor. The memory 265 is representative of the one or more memory devices containing the software and data used to operate the mobile terminal 100, in accordance with some embodiments of the present invention. The memory 265 may include, but is not limited to, the following types of devices: cache, ROM, PROM, EPROM, EEPROM, flash, SRAM, and DRAM.

As shown in FIG. 2, the memory 265 may contain a navigation module 270 and a map module 280. The navigation module 270 may include a navigation application that is configured to receive position data from the GPS receiver circuit 210. In accordance with some embodiments of the present invention, the position data may correspond to the current position of the mobile terminal 100. Once received from the GPS receiver circuit 210, the navigation module 275 may process the positions in various ways including, but not limited to, using them as favorites, waypoints, and the like.

The map module 280 may include a mapping application that is configured to provide a mapping of the earth's surface using Mercator projection map tiles. The mapping may be through cooperation with, for example, a public mapping service, such as those provided by Google Maps, Yahoo Maps, or the like. The map module 280 may be further configured to generate geographical presence information for the mobile terminal 100. In contrast to the conventional techniques for providing geographical presence discussed above in which an exact location or a false position is provided, the map module 280 may provide geographical presence based on map tile coordinates and a zoom level.

Although FIG. 2 illustrates an exemplary software and hardware architecture that may be used to provide the mobile terminal 100 as shown in FIG. 1, it will be understood that the present invention is not limited to such a configuration, but is intended to encompass any configuration capable of carrying out the operations described herein.

Computer program code for carrying out operations of devices and/or systems discussed above with respect to FIGS. 1-2 may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described hereinafter with reference to flowchart and/or block diagram illustrations of methods, mobile terminals, electronic devices, communication networks, and/or computer program products in accordance with some embodiments of the invention. These flowchart and/or block diagrams further illustrate exemplary operations of electronic devices that can provide a geographical presence and methods and computer program products for operating the same. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the message flow, flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the message flow, flowchart and/or block diagram block or blocks.

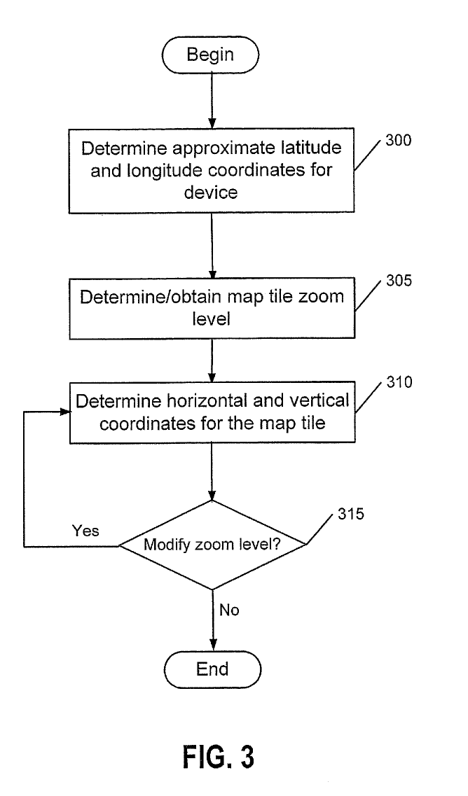

FIG. 3 is a flowchart that illustrates operations of the mobile terminal 100 of FIGS. 1 and 2 in accordance with some embodiments of the present invention. Referring now to FIG. 3, operations begin at block 300 where the map module 280 determines the approximate latitude and longitude coordinates for the mobile terminal 100. In some embodiments of the present invention, the map module 280 may communicate with the navigation module 275 to obtain GPS coordinates for the mobile terminal 100. In other embodiments of the present invention, the map module 280 may display at least a portion of a map on the mobile terminal 100 and allow a user to provide input to identify an approximate geographic location of the mobile terminal 100. The user may change the portion of the map that is displayed on the mobile terminal by panning and/or changing the zoom level.

Operations continue at block 305 where the map module determines/obtains a zoom level for a geographic map tile that encompasses the approximate geographic location of the mobile terminal determined at block 300. If the approximate geographic location of the mobile terminal 100 was obtained based on the user panning a map display and adjusting the zoom thereof, then the zoom level obtained from the user may be used. At block 310, the map module 280 may determine the horizontal and vertical coordinates of the geographic map tile based on the zoom level determined at block 305 and the approximate geographic location of the mobile terminal 100 determined at block 300. In some embodiments of the present invention, if the zoom level is given by Z, the horizontal coordinate has a range from 0 to 2^{Z-1}, and the vertical coordinate has a range from 0 to 2^{Z-1}.

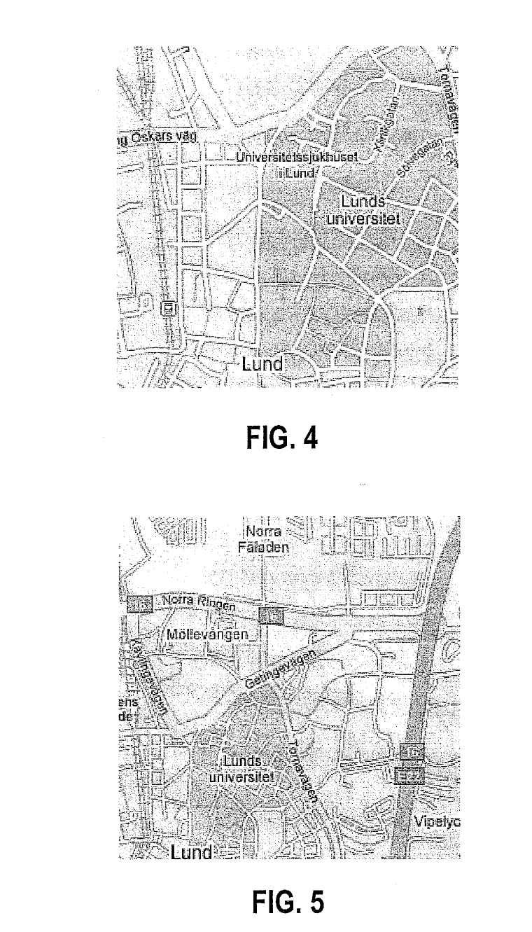

Based on the horizontal coordinate, vertical coordinate, and zoom level for the geographic map tile, the map module 280 may render the geographic presence on the mobile terminal 100 as shown, for example, in FIG. 4. At block 315, the user may adjust the level of obfuscation for the geographic presence by modifying the zoom level. If the zoom level is modified, then the horizontal and vertical coordinates for the geographic map tile are determined again at block 310. This is illustrated, for example, in FIG. 5 where the user reduces the zoom level one step. In some embodiments, a user may wish to define default values for the zoom levels that are based on who the expected recipient is of the geographic presence information. For example, a user may wish to use a street level zoom level for family members, city block level zoom level for friends, and city level zoom level for colleagues.

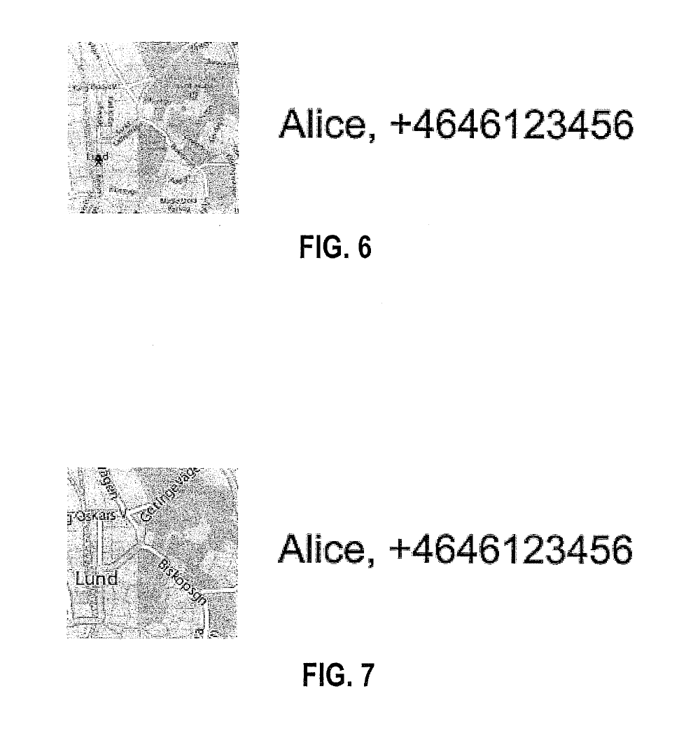

Once the user is satisfied with the level of obfuscation, the user may choose to send the geographic presence to another device, such as mobile terminal 105 of FIG. 1. The geographic presence information can be communicated by sending the horizontal coordinate, vertical coordinate, and zoom level for the geographic map tile, which are determined as described above with respect to FIG. 3, from the mobile terminal 100 to, for example, mobile terminal 105. The receiver of the geographic presence (mobile terminal 105) may use a conventional mapping application to process the geographic presence information to display. The mapping application used on the mobile terminal 100 (sender of geographic presence information) need not be the same mapping application used on the mobile terminal 105 (receiver of geographic presence information). As shown in FIGS. 4 and 5, the geographic presence information may be displayed on the mobile terminal 100 using Google Maps, for example. As shown in FIGS. 6 and 7, the geographic presence information may be displayed on the mobile terminal 105 using Yahoo Maps.

In addition, the screen sizes of mobile terminal 100 and mobile terminal 105 may be different. Accordingly, as shown in FIG. 6, the receiving device (mobile terminal 105) may adjust the image of the geographic presence to fit the size of the display. In FIG. 6, the map tile of the geographic presence image for “Alice” is downscaled. In other embodiments, the receiving device may reduce the zoom level and crop the map tile of the geographic presence image to fit on the display as shown in FIG. 7.

Because the geographic presence information includes valid geographical data with known latitude and longitude coordinates, points of interest (POI) and/or other landmark data may be added to the geographic presence information for display. This additional information may be added at either the sending device or the receiving device in accordance with various embodiments of the present invention.

In further embodiments of the present invention, the mobile terminal 100 may update its presence automatically (if the device is capable of automatically determining its position, through, for example, the navigation module 275 and the map module 280) or manually in response to user input.

Embodiments of the present invention may allow geographic presence information to be shared between devices through use of geographic map tiles, which are used in many mapping applications. Thus, geographic presence information can be shared between users that prefer different mapping applications. The true position of the device is indicated although not revealed due to the properties of the map tile grid. The amount of data that is communicated to indicate geographic presence is relatively small, i.e., horizontal and vertical coordinates along with a zoom level. Nevertheless, this data may represent a complete map image. Moreover, a user may adjust a level of obfuscation relatively easily by adjusting the zoom level for the geographic map tile that represents the geographic presence. The geographic presence also has an implicit default image in case a device's position is indeterminable as the whole world map may be represented in one map tile.

The flowchart of FIG. 3 illustrates the architecture, functionality, and operations of embodiments of electronic devices, methods, and/or computer program products for providing geographical presence. In this regard, each message represents a module, segment, or portion of code, which comprises one or more executable instructions for implementing the specified logical function(s). It should also be noted that in other implementations, the function(s) noted in the messages may occur out of the order noted in FIG. 3. For example, two blocks shown in succession may, in fact, be executed substantially concurrently or the blocks may sometimes be executed in the reverse order, depending on the functionality involved.

In the drawings and specification, there have been disclosed embodiments of the invention and, although specific terms are employed, they are used in a generic and descriptive sense only and not for purposes of limitation, the scope of the invention being set forth in the following claims.

That which is claimed:

1. A method of operating an electronic device, comprising:
determining an approximate geographic location of the electronic device;
determining a zoom level for a geographic map tile that encompasses the approximate geographic location;
determining horizontal and vertical coordinates for the geographic map tile based on the zoom level and the approximate geographic location of the electronic device; and
sending the horizontal and vertical coordinates and zoom level to another device as a geographic presence indicator for the electronic device.

2. The method of claim 1, wherein determining the approximate geographic location comprises using a navigation module to determine the approximate geographic location.

3. The method of claim 2, wherein the navigation module is a Global Positioning System (GPS) unit.

4. The method of claim 1, wherein determining the approximate geographic location comprises:
displaying at least a part of a map on the electronic device; and
receiving user input that identifies the approximate geographic location of the electronic device on the map.

5. The method of claim 4, wherein displaying the at least part of the map comprises:
changing the part of the map displayed on the electronic device responsive to the user input.

6. The method of claim 5, wherein displaying the at least part of the map comprises:
changing the zoom level for the at least part of the map responsive to the user input.

7. The method of claim 1, wherein the zoom level is given by Z, the horizontal coordinate has a range from 0 to 2^{Z-1}, and the vertical coordinate has a range from 0 to 2^{Z-1}.

8. The method of claim 1, further comprising:
changing the zoom level responsive to user input.

9. The method of claim 8, wherein changing the zoom level comprises:
providing a plurality of default zoom levels associated with a plurality of possible recipients of the geographic map tile, respectively; and
receiving a selection of one of the plurality of default zoom levels.

10. The method of claim 1, further comprising:
adding Points Of Interest (POI) to the geographic map tile.

11. The method of claim 1, wherein the electronic device is a mobile terminal.

12. An electronic device, comprising:
a controller configured to determine an approximate geographic location of the electronic device, to determine a zoom level for a geographic map tile that encompasses the approximate geographic location, to determine horizontal and vertical coordinates for the geographic map tile based on the zoom level and the approximate geographic location of the electronic device, and to send the horizontal and vertical coordinates and zoom level to another device as a geographic presence indicator for the electronic device.

13. The electronic device of claim 12, wherein the controller is further configured to determine the approximate geographic location by using a navigation module to determine the approximate geographic location.

14. The electronic device of claim 13, wherein the navigation module is a Global Positioning System (GPS) unit.

15. The electronic device of claim 12, wherein the controller is further configured to determine the approximate geographic location by displaying at least a part of a map on the electronic device and receiving user input that identifies the approximate geographic location of the electronic device on the map.

16. The electronic device of claim 15, wherein the controller is further configured to display the at least part of the map by changing the part of the map displayed on the electronic device responsive to the user input.

17. The electronic device of claim 15, wherein the controller is further configured to display the at least part of the map by changing the zoom level for the at least part of the map responsive to the user input.

18. A computer program product for operating an electronic device, comprising:
a computer readable storage medium having computer readable program code embodied therein, the computer readable program code comprising:
computer readable program code configured to determine an approximate geographic location of the electronic device;
computer readable program code configured to determine a zoom level for a geographic map tile that encompasses the approximate geographic location;
computer readable program code configured to determine horizontal and vertical coordinates for the geographic map tile based on the zoom level and the approximate geographic location of the electronic device; and
computer readable program code configured to send the horizontal and vertical coordinates and zoom level to another device as a geographic presence indicator for the electronic device.

19. The computer program product of claim 18, wherein the computer readable program code configured to determine the approximate geographic location comprises computer readable program code configured to use a navigation module to determine the approximate geographic location.

20. The computer program product of claim 18, wherein computer readable program code configured to determine the approximate geographic location comprises:
computer readable program code configured to display at least a part of a map on the electronic device; and
computer readable program code configured to receive user input that identifies the approximate geographic location of the electronic device on the map.
